(19) United States
(12) Patent Application Publication
(10) Pub. No.: US 2015/0056355 A1
(43) Pub. Date: Feb. 26, 2015

(54) Toaster Broiler for Aircraft Galley

(71) Applicant: B/E AEROSPACE, INC., Wellington, FL (US)

(72) Inventors: Leonard Cusell, Nieuwegein (NL); William J. Godecker, Irvine, CA (US); Sandra Arambula, Hacienda Heights, CA (US)

(21) Appl. No.: 14/466,753

(22) Filed: Aug. 22, 2014

Related U.S. Application Data
(60) Provisional application No. 61/869,386, filed on Aug. 23, 2013.

(51) Int. Cl. A47J 37/06; A23L 1/01

(52) U.S. Cl. CPC A47J 37/0694; A23L 1/01; A23V 2002/00
USPC 426/523; 99/339

(57) ABSTRACT

An apparatus for toasting and broiling a food item in an aircraft galley includes: a heating element that heats a food item; a lower rack upon which the food item sits; an upper rack disposed above the lower rack to contain the food item in position between the lower rack and the upper rack while the heating element heats the food item; and an oven compartment in which the heating element, lower rack, and upper rack are disposed.

### CROSS-REFERENCE TO RELATED APPLICATIONS

This Application claims the priority benefit of U.S. Provisional Application No. 61/869,386, filed Aug. 23, 2013, entitled, “Toaster Broiler for Aircraft Galley.” The above-referenced application is herein incorporated by reference in its entirety.

### BACKGROUND

Embodiments relate to food preparation equipment on an aircraft. More specifically, embodiments relate to a toaster broiler for an aircraft galley.

Use of conventional toaster ovens onboard an aircraft or other vehicle could result in the spilling of food inside the toaster oven due to movement of the toaster oven in response to dynamic events such as vibrations, turbulence, and motion of the aircraft or other vehicle. This could result in spilled food coming into contact with radiant heating elements in the toaster oven.

### SUMMARY

According to an embodiment, an apparatus for toasting and broiling a food item in an aircraft galley includes: a heating element that heats a food item; a lower rack upon which the food item sits; an upper rack disposed above the lower rack to contain the food item in position between the lower rack and the upper rack while the heating element heats the food item; and an oven compartment in which the heating element, lower rack, and upper rack are disposed.

According to another embodiment, a method of toasting and broiling a food item includes: providing a toaster broiler comprising within an oven compartment a heating element, a plurality of first rack guides disposed on a first side wall of the oven compartment, and a plurality of second rack guides disposed on a second side wall of the oven compartment opposite the first side wall; securing a lower rack on a lower first rack guide and on a lower second rack guide; placing the food item on the lower rack; securing an upper rack on an upper first rack guide and on an upper second rack guide, the upper rack positioned above the lower rack to contain the food item in position between the lower rack and the upper rack; and operating the heating element to heat the food item.

### BRIEF DESCRIPTION OF THE DRAWINGS

Exemplary embodiments will be explained in more detail with reference to the attached drawings in which the embodiments are illustrated as briefly described below.

FIG. 1 is a front view of a toaster broiler for an aircraft galley, according to an embodiment.

FIG. 2 is a flowchart for operating the toaster broiler, according to an embodiment.

### DETAILED DESCRIPTION

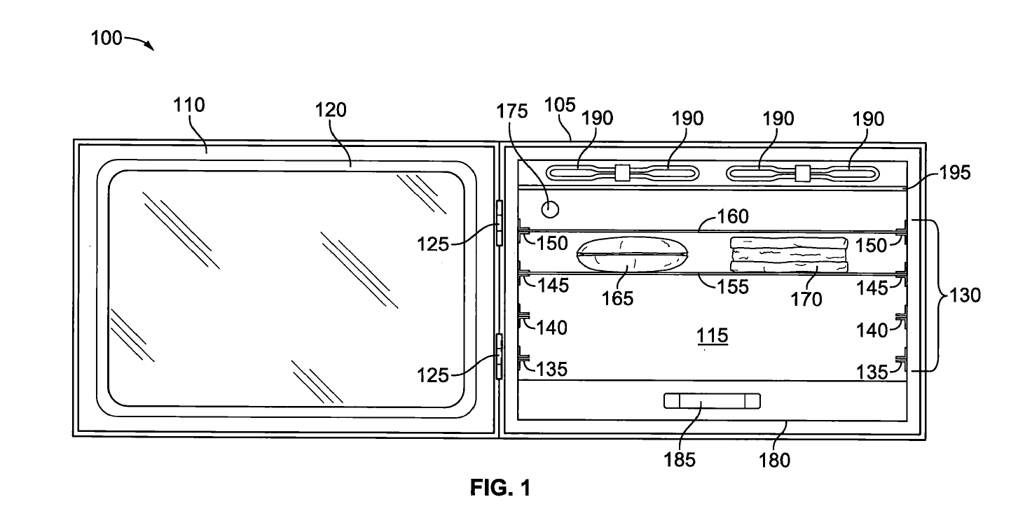

FIG. 1 illustrates a toaster broiler 100 for an aircraft galley, according to an embodiment. The toaster broiler 100 incorporates dedicated toasting and broiling functions into an oven for an aircraft galley. The toaster broiler 100 prepares toasted bread, including bread slices, buns, bagels, English muffins, and the like as well as appetizers and meal starters including bruschettas and crostinis. The toaster broiler 100 also features an ergonomic user interface and harmonization with other appliances in the aircraft galley.

The toaster broiler 100 includes safety mechanisms that overcome the unique difficulties in providing toaster and broiler functions onboard an aircraft. In a conventional toaster oven when used onboard an aircraft, food can spill, become dislodged, and touch a radiant heating element of the toaster oven when the toaster oven vibrates, jostles, turns, and moves in response to dynamic events such as vibrations, turbulence, and motion of the aircraft. In contrast, the toaster broiler 100 incorporates an upper and lower rack system 130 that constrains motion of food during motion of the toaster broiler 100, for example, during dynamic events of the aircraft. The upper and lower rack system 130 thus prevents the food in the toaster broiler 100 from spilling, becoming dislodged, and touching a heating element of the toaster broiler 100 during dynamic events. The upper and lower rack system 130 also facilitates ease of loading food items into and removing food items from the toaster broiler 100.

The toaster broiler 100 includes an outer housing 105 and a door 110 defining the boundaries of an oven compartment 115. The door 110 includes a seal 120 that seals the door 110 against front edges of the outer housing 105 to close the oven compartment 115. The door 110 includes hinges 125 that attach the door 110 to the outer housing 105 and facilitate the door 110 opening and closing the oven compartment 115. The door 110 also includes a vent for ventilation of the oven compartment 115.

The oven compartment 115 includes an upper and lower rack system 130 that constrains motion of food during motion of the toaster broiler 100, for example, during dynamic events of the aircraft. The rack system 130 includes rack guides 135, 140, 145, and 150 at different heights on either side of the oven compartment 115. In various embodiments, there are more or fewer lower rack guides than the lower rack guides 135, 140, and 145 arranged in a vertical direction. A rack 155 may be placed on any one of the lower rack guides 135, 140, and 145 to facilitate a desired vertical spacing between the rack 155 and a rack 160 supported by a higher rack guide, e.g., one of the lower rack guides 140 and 145 or the upper rack guide 150. The desired vertical spacing may be sufficiently large to facilitate food 165 and 170 to be placed on the rack 155 and constrained from moving, tipping, or spilling by the rack 160 above the food 165 and 170.

The food 165 and 170 may be a sandwich, sub, bun, Panini, baguette, or other food product desired to be heated or toasted in the toaster broiler 100. The food 165 and 170 may also include various spreads and toppings.

A user may place the racks 155 and 160 on different rack guides 135, 140, 145, and 150 using an oven mitt or a tool that protects the user from physically touching the pair of the rack guides 135, 140, 145, and 150, or any racks 155 or 160 situated on the pair of the rack guides 135, 140, 145, and 150. The user may move one or both of the racks 155 and 160 from one set of rack guides to another set of rack guides to change the spacing between the racks 155 and 160, or to change a distance of the food 165 and 170 from heating elements 190.

The racks 155 and 160 and upper and lower rack guides 135, 140, 145, and 150 are constructed of a material resistant to high temperatures and easy to clean. The racks 155 and 160 and upper and lower rack guides 135, 140, 145, and 150 are also constructed to be relatively low in weight, while being capable of withstanding large weight food products being placed on the racks. The racks 155 and 160 and upper and lower rack guides 135, 140, 145, and 150 are also constructed of a material with a low heat capacity to facilitate the racks 155 and 160 and upper and lower rack guides 135, 140, 145, and 150 cooling down quickly to prevent burns by a user inadvertently touching the racks 155 and 160 and upper and lower rack guides 135, 140, 145, and 150, for example when removing food 165 and 170 from the racks 155 and 160 after a toasting or broiling cycle, or placing new food 165 and 170 on the racks 155 and 160 for another toasting or broiling cycle.

The racks 155 and 160 and upper and lower rack guides 135, 140, 145, and 150 are held in place in the oven compartment 115 to prevent being dislodged and coming out of the oven compartment 115 during dynamic events of the aircraft. The racks 155 and 160 may be tight fitting in the rack guides 135, 140, 145, and 150 and the oven compartment 115 in order to prevent noise from rattling and reduce wear and tear on the racks 155 and 160, rack guides 135, 140, 145, and 150, and the interior surfaces of the oven compartment 115.

The racks 155 and 160 may be constructed of wire mesh, grill, or plates. A plate may prevent dripping from the racks 155 and 160 for ease of cleaning and prevention of food sitting on one rack 155 from spilling over to food on a lower rack 155. In addition, a plate may exhibit a mirror effect and be used to limit heating from the heating elements 190 to a region above the plate and not to regions below the plate. Use of a plate as a rack 155 may enhance ease of cleaning of the toaster broiler 100.

Below the upper and lower rack system 130, the oven compartment 115 includes a crumb tray 180. The crumb tray 180 catches any crumbs, grease, drippings, and spills from the food 165 and 170. The crumb tray 180 is easily removable and cleanable by pulling the crumb tray 180 out of the oven compartment 115. The crumb tray 180 may include a crumb tray handle 185 or other means for removing the crumb tray 180 from the oven compartment 115. The crumb tray 180 is held in place when the oven door 110 is open to prevent falling out of the oven compartment 115 during dynamic events of the aircraft, for example. The crumb tray 180 fits tightly within the oven compartment 115 to prevent noise from rattling, etc., during dynamic events, and to prevent excessive wear and tear on the interior surfaces of the oven compartment 115 and the crumb tray 180 during operation in a high vibration and turbulence aircraft environment.

The oven compartment 115 includes one or more heating elements 190, which, according to the illustrated embodiment, may be located above the upper and lower rack system 130. According to an alternative embodiment, heating elements may be located below the upper and lower rack system 130, and, according to yet a further embodiment, heating elements may be located both above and below the upper and lower rack system 130. The oven compartment may include a heating element screen 195 that prevents the food 165 and 170, users' hands, and other foreign objects from touching the heating elements 190. The heating element screen 195 may be touched by the food 165 and 170, the users' hands, and other foreign objects without burning the food 165 and 170, the users' hands, and other foreign objects.

The heating elements 190 may be electrical heating elements that operate by heating when electrical current passes through the heating elements 190. In various embodiments, the heating elements 190 may be tubular, may be mica wound heating elements, or may be other types of heating elements known in the art. The heating elements 190 may be thermally isolated from an exterior of the oven compartment 115 and an exterior surface of the outer housing 105 in order to prevent excessive temperatures on the exterior surface of the outer housing 105 and exterior of the oven compartment 115. The thermal isolation may prevent temperature transmission due to a thermal bridge between the heating elements 190 and the exterior of the oven compartment 115 and exterior surface of the outer housing 105.

The heating elements 190 may be configured for use in a multiple-phase alternating current (AC) power system such as that onboard an aircraft. In an embodiment, the heating elements 190 are phase balanced. There may be one heating element 190 dedicated to each phase of a three-phase AC power system. In another embodiment, there are multiple heating elements 190 which operate together using a single phase.

The back of the oven compartment 115 also includes a vent connection 175 to facilitate venting of air in the oven compartment 115. The vent connection 175 may facilitate air circulation within the oven compartment 115.

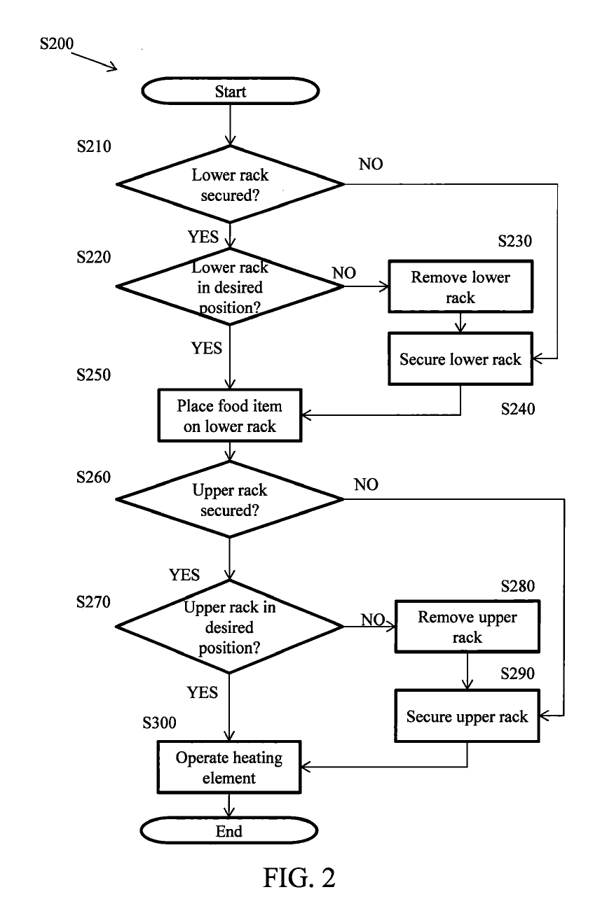

FIG. 2 is a flowchart illustrating an exemplary method for using S200 the toaster broiler 100. Initially, the lower rack is checked to see if it is secured S210. If so S210:Yes, and if it is in the desired position S220:Yes, then a food item is placed on the lower rack S250. If the lower rack is in the wrong position S220:No, then the lower rack is removed S230 and placed in the proper position. The non-secured rack S210:No is then secured S240.

Then, the upper rack is checked to see if it is secured S260. If so S260:Yes, and if it is in the desired position S270:Yes, then the heating element is operated S300. If the upper rack is in the wrong position S270:No, then the upper rack is removed S280 and placed in the proper position. The non-secured rack S270:No is then secured S290.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. An apparatus for toasting and broiling a food item in an aircraft galley, the apparatus comprising:
a heating element that heats a food item;
a lower rack upon which the food item sits;
an upper rack disposed above the lower rack to contain the food item in position between the lower rack and the upper rack while the heating element heats the food item; and
an oven compartment in which the heating element, lower rack, and upper rack are disposed.

2. The apparatus of claim 1, wherein a vertical position of at least one of the lower rack and the upper rack is variable.

3. The apparatus of claim 1, further comprising:
a plurality of first rack guides disposed on a first side wall of the oven compartment; and
a plurality of second rack guides disposed on a second side wall of the oven compartment opposite the first side wall,
wherein the lower rack and upper rack are positioned on the first and second rack guides.

4. The apparatus of claim 3, wherein the lower rack and the upper rack are adapted to be press fit into the first and second rack guides.

5. The apparatus of claim 3, wherein the first and second rack guides are positioned at different heights on the first side wall and the second side wall.

6. A method of toasting and broiling a food item, the method comprising:
providing a toaster broiler comprising within an oven compartment a heating element, a plurality of first rack guides disposed on a first side wall of the oven compartment, and a plurality of second rack guides disposed on a second side wall of the oven compartment opposite the first side wall;
securing a lower rack on a lower first rack guide and on a lower second rack guide;
placing the food item on the lower rack;
securing an upper rack on an upper first rack guide and on an upper second rack guide, the upper rack positioned above the lower rack to contain the food item in position between the lower rack and the upper rack; and
operating the heating element to heat the food item.

7. The method of claim 6, wherein the lower rack and the upper rack are press fit into the first and second rack guides.
